(19) United States
(12) Patent Application Publication
(10) Pub. No.: US 2014/0063361 A1
(43) Pub. Date: Mar. 6, 2014

(54) TOUCH PANEL

(71) Applicants: DONGGUAN MASSTOP LIQUID CRYSTAL DISPLAY CO., LTD., Dongguan City (CN); WINTEK CORPORATION, Taichung City (TW)

(72) Inventors: Chin-Wen Lo, Taichung City (TW); Yu-Ching Tu, Yunlin County (TW); Ming-Chuan Lin, Taichung City (TW); Hsueh-Chih Wu, Taichung City (TW); Yi-Chun Lin, Changhua County (TW); Shin-Chieh Huang, Taichung City (TW); Hsuan-Ta Chen, Keelung City (TW); Yu-Chen Fang, Taichung City (TW); Ping-Wen Huang, Taichung City (TW)

(73) Assignees: WINTEK CORPORATION, Taichung City (TW); DONGGUAN MASSTOP LIQUID CRYSTAL DISPLAY CO., LTD., Dongguan City (CN)

(21) Appl. No.: 13/854,967

(22) Filed: Apr. 2, 2013

(30) Foreign Application Priority Data
Sep. 3, 2012 (TW) 101132037

(51) Int. Cl. G06F 1/16

(52) U.S. Cl. CPC G06F 1/16
USPC 349/12

(57) ABSTRACT

A touch panel, having a touch sensing region and a peripheral region adjacent to at least one edge of the touch sensing region, includes a cover substrate and a decoration border. The cover substrate has a touch surface and an inner surface opposite to the touch surface. The decoration border is disposed on the inner surface of the cover substrate within the peripheral region. The decoration border includes a first non-black decoration layer and a second non-black decoration layer. The second non-black decoration layer is disposed on the first decoration layer. The first non-black decoration layer is disposed between the cover substrate and the second non-black decoration layer. The second non-black decoration layer covers the first non-black decoration layer along a vertical projective direction. A pattern size of the second non-black decoration layer is larger than a pattern size of the first non-black decoration layer.

### BACKGROUND OF THE INVENTION

1. Field of the Invention

The present invention relates to a touch panel, and more particularly, to a touch panel including multiple layers of non-black decoration layers disposed in a peripheral region of the touch panel.

2. Description of the Prior Art

Please refer to FIG. 1 and FIG. 2. FIG. 1 is a schematic diagram illustrating a conventional touch panel. FIG. 2 is a schematic diagram illustrating a cross sectional view of a region P in FIG. 1. As shown in FIG. 1, a touch panel 10 includes a color decoration layer 12. A light-shielding property of the color decoration layer 12 is usually insufficient when the color decoration layer 12 consists of other color ink instead of black ink, and a thickness of the color decoration layer 12 has to be much thicker for providing required light-shielding performance. As shown in FIG. 2, the color decoration layer 12 consists five ink layers disposed in a stack configuration. A total thickness of the color decoration layer 12 is around 30 micrometers to 40 micrometers. Accordingly, a subsequently formed transparent electrode or wiring, such as a electrode 14 crossing the color decoration layer 12, may have a crack problem caused by a height variation of the color decoration layer 12, and the reliability of the touch panel 10 may also be influenced.

Please refer to FIG. 3. FIG. 3 is a schematic diagram illustrating another conventional touch panel. As shown in FIG. 3, a touch panel 100 has a touch sensing region R1 and a peripheral region R2 adjacent to at least one edge of the touch sensing region R1. The touch panel 100 includes a cover glass 110. A plurality of color ink layers 120, a light-shielding layer 130, and an outer trace 140 are successively disposed in a stack configuration on the cover glass 110 within the peripheral region R2. A touch sensing electrode 150 is disposed in the touch sensing region R1, and the touch sensing electrode 150 is electrically connected with the outer trace 140 in the peripheral region R2 through a connecting line 160. The color ink layers 120 are used to present a required color effect on the peripheral region R2 of the touch panel 100 by mixing colors. A ladder-shaped structure is formed by edges of the adjacent color ink layers 120 because a size of the subsequently formed color ink layer 120 is slightly smaller than a size of the formerly formed color ink layer 120. Accordingly, the connecting line 160 may extend along the ladder-shaped structure formed by the stacked color ink layers 120 for being electrically connected with the outer trace 140, and the crack issue and the reliability of the touch panel 100 may be relatively improved comparing to the above-mentioned structure in FIG. 2. However, when the amount of the stacked color ink layers 120 increases, the contour variation may become more severe on the edge of the stacked color ink layers 120. The connecting line 160 may still probably crack on the side edge of the stacked color ink layers 120, and the manufacturing yield and the reliability of the touch panel 100 may still be influenced.

### SUMMARY OF THE INVENTION

It is one of the objectives of the present invention to provide a touch panel. Non-black decoration layers are disposed in a stacked configuration within a peripheral region of the touch panel. The upper non-black decoration layer covers the lower non-black decoration layer, and a crack problem of a subsequently formed connecting line on the stacked non-black decoration layers may be accordingly improved.

To achieve the purposes described above, a preferred embodiment of the present invention provides a touch panel, having a touch sensing region and a peripheral region adjacent to at least one edge of the touch sensing region. The touch panel includes a cover substrate and a decoration border. The cover substrate has a touch surface and an inner surface opposite to the touch surface. The decoration border is disposed on the inner surface of the cover substrate within the peripheral region. The decoration border includes a first non-black decoration layer and a second non-black decoration layer. The second non-black decoration layer is disposed on the first non-black decoration layer. The first non-black decoration layer is disposed between the cover substrate and the second non-black decoration layer. The second non-black decoration layer covers the first non-black decoration layer along a vertical projective direction. A pattern size of the second non-black decoration layer is larger than a pattern size of the first non-black decoration layer.

To achieve the purposes described above, another preferred embodiment of the present invention provides a touch panel, having a touch sensing region and a peripheral region adjacent to at least one edge of the touch sensing region. The touch panel includes a cover substrate and a decoration border. The decoration border is disposed on the cover substrate within the peripheral region. The decoration border includes a first non-black decoration layer and a second non-black decoration layer. The second non-black decoration layer is adjacent to the first non-black decoration layer. The first non-black decoration layer is disposed between the cover substrate and the second non-black decoration layer. The second non-black decoration layer encompasses the first non-black decoration layer along a vertical projective direction.

To achieve the purposes described above, another preferred embodiment of the present invention provides a touch panel, having a touch sensing region and a peripheral region adjacent to at least one edge of the touch sensing region. The touch panel includes a cover substrate and a decoration border. The decoration border is disposed on the cover substrate within the peripheral region. The decoration border includes a first non-black decoration layer and a second non-black decoration layer. The second non-black decoration layer is adjacent to the first non-black decoration layer. The first non-black decoration layer is disposed between the cover substrate and the second non-black decoration layer. The second non-black decoration layer covers the first non-black decoration layer along a vertical projective direction.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a conventional touch panel.

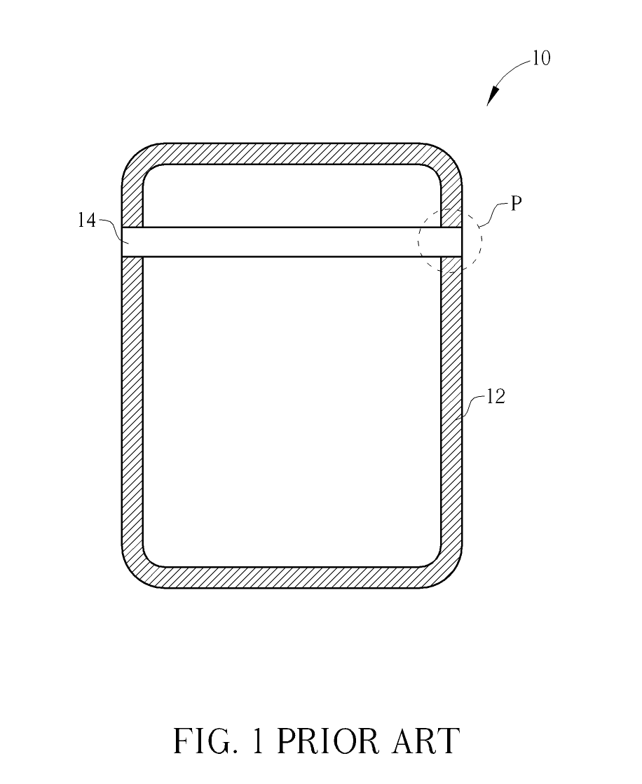

FIG. 2 is a schematic diagram illustrating a cross sectional view of a region P in FIG. 1.

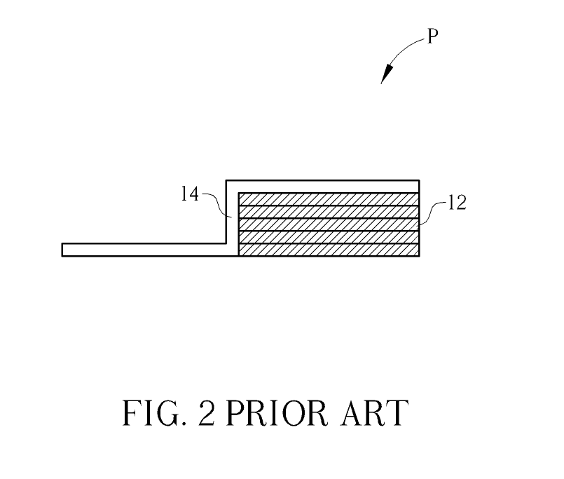

FIG. 3 is a schematic diagram illustrating another conventional touch panel.

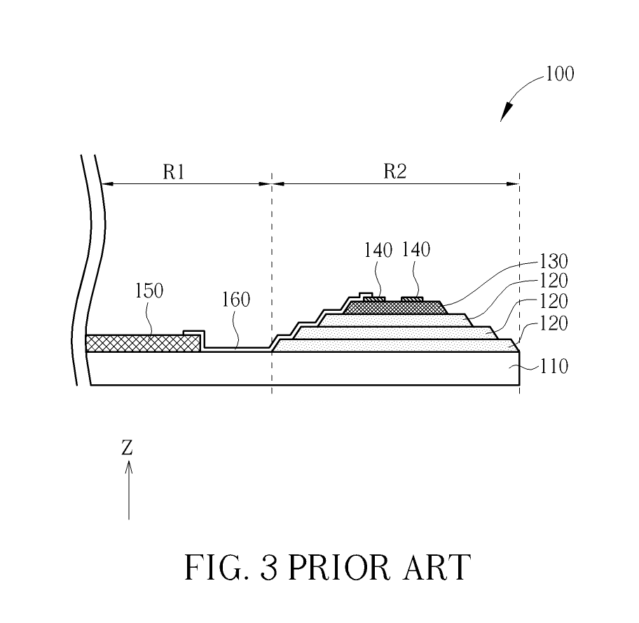

FIG. 4 is a schematic diagram illustrating a touch panel according to a first preferred embodiment of the present invention.

FIG. 5 is a schematic diagram illustrating a top view of the touch panel according to the first preferred embodiment of the present invention.

FIG. 6 is a schematic diagram illustrating a touch panel according to a second preferred embodiment of the present invention.

FIG. 7 is a schematic diagram illustrating a touch panel according to a third preferred embodiment of the present invention.

FIG. 8 is a schematic diagram illustrating a touch panel according to a fourth preferred embodiment of the present invention.

FIG. 9 is a schematic diagram illustrating a touch panel according to a fifth preferred embodiment of the present invention.

FIG. 10 is a schematic diagram illustrating a touch panel according to a sixth preferred embodiment of the present invention.

FIG. 11 is a schematic diagram illustrating a touch panel according to a seventh preferred embodiment of the present invention.

FIG. 12 is a schematic diagram illustrating a touch panel according to an eighth preferred embodiment of the present invention.

FIG. 13 is a schematic diagram illustrating a touch panel according to a ninth preferred embodiment of the present invention.

FIG. 14 is a schematic diagram illustrating a touch panel according to a tenth preferred embodiment of the present invention.

FIG. 15 is a schematic diagram illustrating a touch panel according to an eleventh preferred embodiment of the present invention.

FIG. 16 is a schematic diagram illustrating a top view of a touch panel according to a twelfth preferred embodiment of the present invention.

FIG. 17 is a schematic diagram illustrating a cross-sectional view of the touch panel according to the twelfth preferred embodiment of the present invention.

FIG. 18 is a schematic diagram illustrating a touch panel according to a thirteenth preferred embodiment of the present invention.

FIG. 19 is a schematic diagram illustrating a touch panel according to a fourteenth preferred embodiment of the present invention.

FIG. 20 is a schematic diagram illustrating a touch panel according to a fifteenth preferred embodiment of the present invention.

### DETAILED DESCRIPTION

In the following description, numerous specific details are given to provide a thorough understanding of a touch panel related to the invention. In addition, reference is made to the accompanying drawings, which form a part hereof, and in which is shown by way of illustration specific examples in which the embodiments may be practiced.

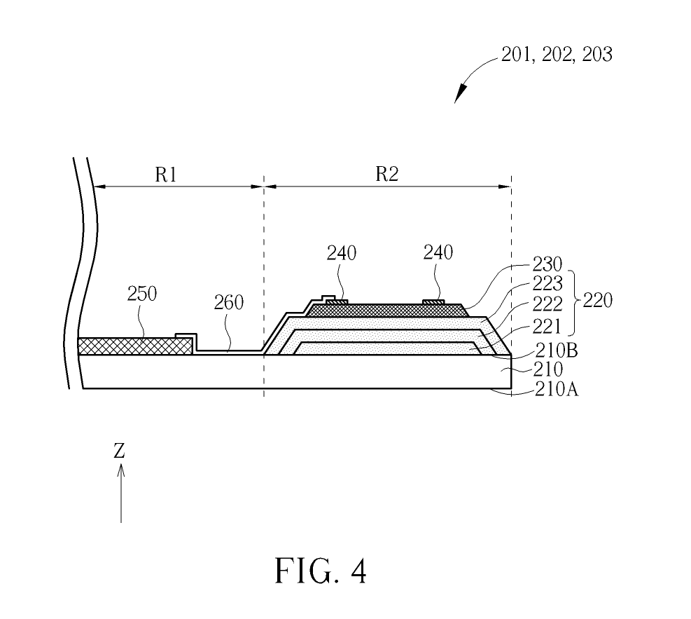

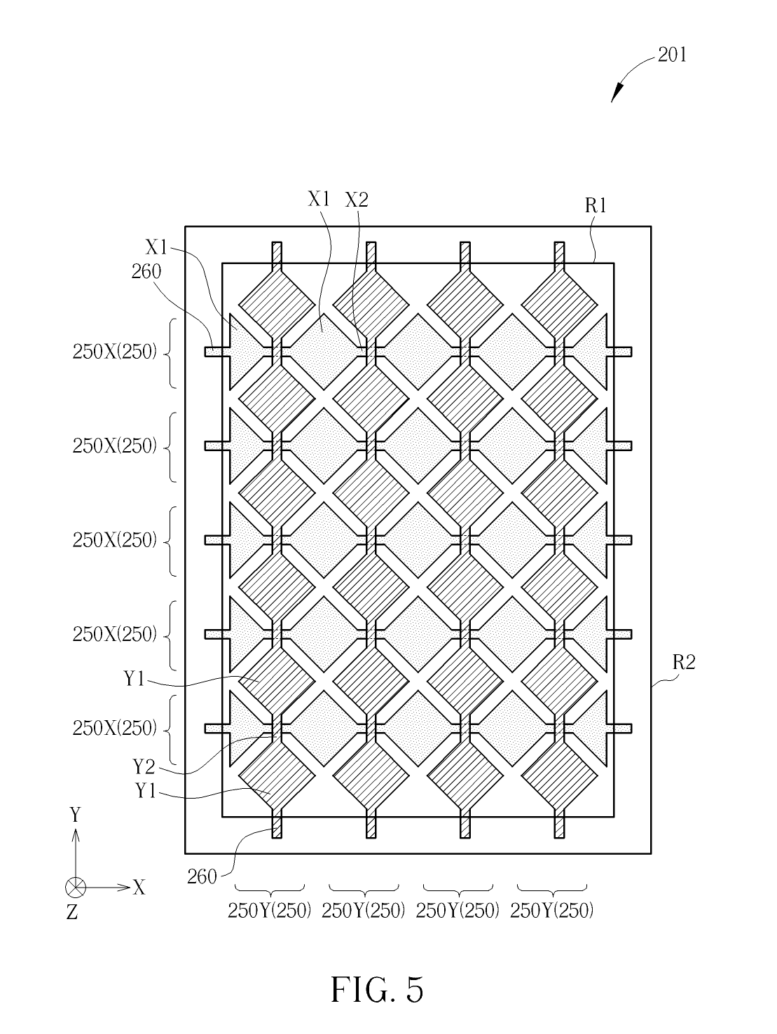

Please refer to FIG. 4 and FIG. 5. FIG. 4 is a schematic diagram illustrating a touch panel according to a first preferred embodiment of the present invention. FIG. 5 is a schematic diagram illustrating a top view of the touch panel according to this embodiment. Please note that the figures are only for illustration and the figures may not be to scale. The scale may be further modified according to different design considerations. As shown in FIG. 4 and FIG. 5, the first preferred embodiment of the present invention provides a touch panel 201, and the touch panel 201 has a touch sensing region R1 and a peripheral region R2 adjacent to at least one edge of the touch sensing region R1. In this embodiment, the peripheral region R2 surrounds the touch sensing region R1, but the present invention is not limited to this. In other preferred embodiment of the present invention, the peripheral region R2 may be disposed adjacently only to partial edge of the touch sensing region R1 according to other design considerations. The touch panel 201 includes a cover substrate 210 and a decoration border 220. The cover substrate 210 has a touch surface 210A and an inner surface 210B opposite to the touch surface 210A. The decoration border 220 is disposed on the inner surface 210B of the cover substrate 210 within the peripheral region R2. The decoration border 220 includes a first non-black decoration layer 221 and a second non-black decoration layer 222. The second non-black decoration layer 222 is disposed on the first non-black decoration layer 221. The first non-black decoration layer 221 is disposed between the cover substrate 210 and the second non-black decoration layer 222. In other words, the second non-black decoration layer 222 is adjacent to the first non-black decoration layer 221. The second non-black decoration layer 222 covers the first non-black decoration layer 222 along a vertical projective direction Z. A pattern size of the second non-black decoration layer 222 is larger than a pattern size of the first non-black decoration layer 221. In other words, the first non-black decoration layer 221 is completely surrounded by the cover substrate 210 and the second non-black decoration layer 222. The second non-black decoration layer 222 encompasses the first non-black decoration layer 221. Additionally, the decoration border 220 may selectively include a third non-black decoration layer 223 disposed on the second non-black decoration layer 222. The third non-black decoration layer 223 covers the second non-black decoration layer 222 and the first non-black decoration layer 221 along the vertical projective direction Z, and a pattern size of the third non-black decoration layer 223 is larger than the pattern size of the second non-black decoration layer 222. In other words, the first non-black decoration layer 221 and the second non-black decoration layer 222 are completely surrounded by the cover substrate 210 and the third non-black decoration layer 223. A demanded decoration effect may be presented on the peripheral region R2 of the touch panel 201 by stacking the first non-black decoration layer 221, the second non-black decoration layer 222, and the third non-black decoration layer 223 in the peripheral region R2 and modifying colors of the first non-black decoration layer 221, the second non-black decoration layer 222, and the third non-black decoration layer 223.

In this embodiment, the colors of the first non-black decoration layer 221, the second non-black decoration layer 222, and the third non-black decoration layer 223 may be identical for design considerations. For example, the first non-black decoration layer 221, the second non-black decoration layer 222, and the third non-black decoration layer 223 may respectively be a white decoration layer, and a total optical density (OD) of the decoration border 220 may be increased by stacking the first non-black decoration layer 221, the second non-black decoration layer 222, and the third non-black decoration layer 223, but the present invention is not limited to this. In other preferred embodiments of the present invention, the first non-black decoration layer 221, the second non-black decoration layer 222, and the third non-black decoration layer 223 with different colors may also be employed to present required color effects by color mixing. In addition, an optical density of the second non-black decoration layer 222 is preferably higher than an optical density of the first non-black decoration layer 221, and an optical density of the third non-black decoration layer 223 is preferably higher than the optical density of the second non-black decoration layer 222, but not limited thereto. The first non-black decoration layer 221, the second non-black decoration layer 222, and the third non-black decoration layer 223 may include a color ink layer, a color photoresist layer, or a metal layer. A demanded color or metallic appearance may be obtained by stacking the first non-black decoration layer 221, the second non-black decoration layer 222, and the third non-black decoration layer 223. More specifically, the first non-black decoration layer 221, the second non-black decoration layer 222, and the third non-black decoration layer 223 may be three identical material layers such as three color ink layers, three color photoresist layers, or three metal layers. Otherwise, the first non-black decoration layer 221, the second non-black decoration layer 222, and the third non-black decoration layer 223 may respectively be different materials. For instance, the first non-black decoration layer 221, the second non-black decoration layer 222, and the third non-black decoration layer 223 may be two color ink layers accompanied with one metal layer, or two color photoresist layers accompanied with one metal layer, but not limited thereto. The first non-black decoration layer 221, the second non-black decoration layer 222, and the third non-black decoration layer 223 may be formed on the cover substrate 210 by a screen printing process, a photo process, an etching process, or other appropriate processes.

As shown in FIG. 4 and FIG. 5, the touch panel 201 may further include a first light-shielding layer 230, a conductive wiring 240, a touch sensing unit 250, and a connecting portion 260. The first light-shielding layer 230 is disposed on the decoration border 220. The first light-shielding layer 230 may be a black ink layer or a metal layer. The conductive wiring 240 is disposed on the decoration border 220 within the peripheral region R2. More specifically, the conductive wiring 240 is disposed on the first light-shielding layer 230 within the peripheral region R2, and the first light-shielding layer 230 is used to shield the conductive wiring 240, but not limited thereto. The touch sensing unit 250 is disposed on the inner surface 210B of the cover substrate 210 within the touch sensing region R1. The connecting portion 260 is disposed on the inner surface 210B of the cover substrate 210, and the connecting portion 260 is used to electrically connect the touch sensing unit 250 and the conducting wiring 240. In this embodiment, the cover substrate 210 may preferably include a rigid substrate such as a cover glass and a cover lens, a flexible substrate such as plastic substrate, or substrates made of other appropriate materials. The conductive wiring 240 and the connecting portion 260 may preferably include transparent conducive materials such as indium tin oxide (ITO), indium zinc oxide (IZO), aluminum zinc oxide (AZO), opaque conductive materials such as silver (Ag), aluminum (Al), copper (Cu), magnesium (Mg), molybdenum (Mo), a stack layer of the above-mentioned materials, or an alloy of the above-mentioned materials, but not limited thereto. The touch sensing unit 250 may be electrically connected to the conductive wiring 240 through the connecting portion 260. The touch sensing unit 250 may be further electrically connected to other devices (not shown) such as a control integrated circuit (control IC) though the conductive wiring 240, and the touch sensing unit 250 may then be driven by the control IC. It is worth noting that the connecting portion 260 in this embodiment extends along a side edge of the decoration border 220 for being electrically connected to the conductive wiring 240. Problems such as cracks in connecting portion 260 caused by a contour variation on the side edge of the decoration border 220 composed of multiple decoration layers may be accordingly improved because the upper non-black decoration layer wraps the lower non-black decoration layer in the decoration border 220 within the peripheral region R2. Additionally, a width and space control of the conductive wiring 240 may be more flexible because the upper non-black decoration layer or the first light-shielding layer may become larger.

As shown in FIG. 5, the touch sensing unit 250 in this embodiment may preferably include a plurality of first axis electrodes 250X and a plurality of second axis electrodes 250Y. The first axis electrodes 250X cross the second axis electrodes 250Y spatially separated from the first axis electrodes 250X by a insulation layer or insulators at the crossovers of the first axis electrodes 250X and the second axis electrodes 250Y. Each of the first axis electrodes 250X extends along a first direction X, each of the second axis electrodes 250Y extends along a second direction Y, and the first direction X is substantially perpendicular to the second direction Y, but not limited thereto. Each of the first axis electrodes 250X includes a plurality of first sensing electrodes X1 and a plurality of first connecting lines X2 disposed in the touch sensing region R1. Each of the second axis electrodes 250Y includes a plurality of second sensing electrodes Y1 and a plurality of second connecting lines Y2 disposed in the touch sensing region R1. The first sensing electrodes X1 and the second sensing electrodes Y1 are uniformly distributed in the touch sensing region R1 for touch sensing. The first connecting lines X2 are used to electrically connect the first sensing electrodes X1 within the same first axis electrode 250X, and the second connecting lines Y2 are used to electrically connect the second sensing electrodes Y1 within the same second axis electrode 250Y. The connecting portions 260 are electrically connected to each of the first axis electrodes 250X and each of the second axis electrodes 250Y, and the connecting portions 260 extend to the peripheral region R2 for being electrically to the conductive wiring (not shown in FIG. 5).

The following description will detail the different embodiments of the touch panel in the present invention. To simplify the description, identical components in each of the following embodiments are marked with identical symbols. For making it easier to understand the differences between the embodiments, the following description will detail the dissimilarities among different embodiments and the identical features will not be redundantly described.

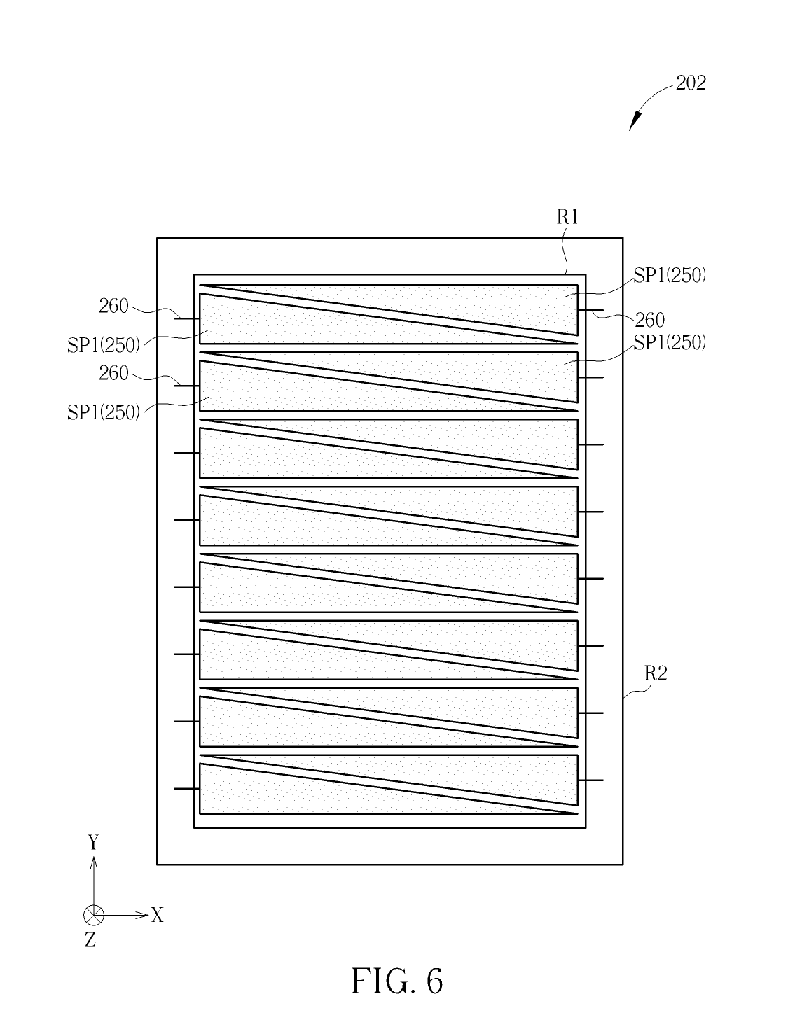

Please refer to FIG. 4 and FIG. 6. FIG. 6 is a schematic diagram illustrating a touch panel according to a second preferred embodiment of the present invention. As shown in FIG. 4 and FIG. 6, the second preferred embodiment of the present invention provides a touch panel 202. The difference between the touch panel 202 of this embodiment and the first preferred embodiment described above is that the touch sensing unit 250 in the touch panel 202 includes a plurality of sensing electrodes SP1 disposed separately with each other in the touch sensing region R1 for touch sensing purposes. The connecting portion 260 is connected to the sensing electrode SP1 and extends to the peripheral region R2 for being electrically connected to the conductive wiring 240. Apart from the sensing electrode SP1 in this embodiment, the other components, allocations, and material properties of the touch panel 202 in this embodiment are similar to those of the first preferred embodiment detailed above and will not be redundantly described. It is worth noting that each of the sensing electrodes SP1 is preferably a triangle electrode, but the present invention is not limited to this. The sensing electrodes SP1 in other different shapes may also be uniformly disposed in the touch sensing region R1 for generating required touch sensing performances.

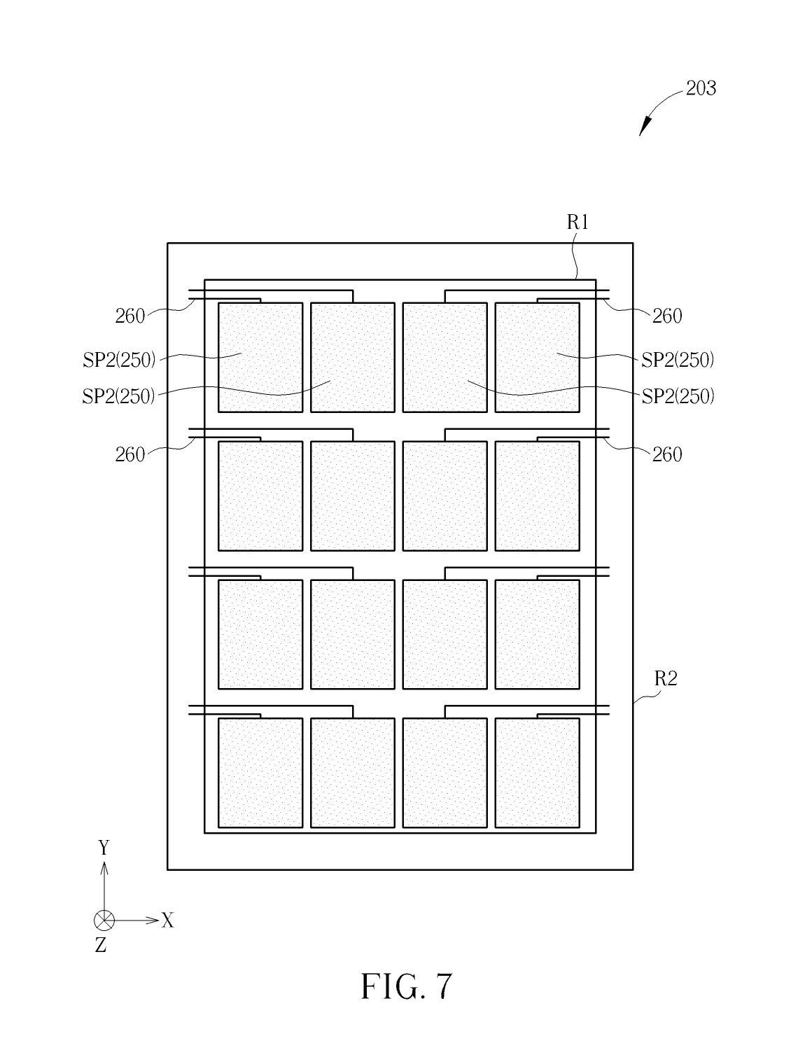

Please refer to FIG. 4 and FIG. 7. FIG. 7 is a schematic diagram illustrating a touch panel according to a third preferred embodiment of the present invention. As shown in FIG. 4 and FIG. 7, the third preferred embodiment of the present invention provides a touch panel 203. In the touch panel 203, the touch sensing unit 250 preferably includes a plurality of sensing electrodes SP2 disposed separately with each other in the touch sensing region R1 for touch sensing purposes. Each of the sensing electrodes SP2 is preferably a rectangle electrode, but the present invention is not limited to this. The sensing electrodes SP2 in other regular or irregular shapes may also be uniformly disposed in the touch sensing region R1 for generating required touch sensing performances.

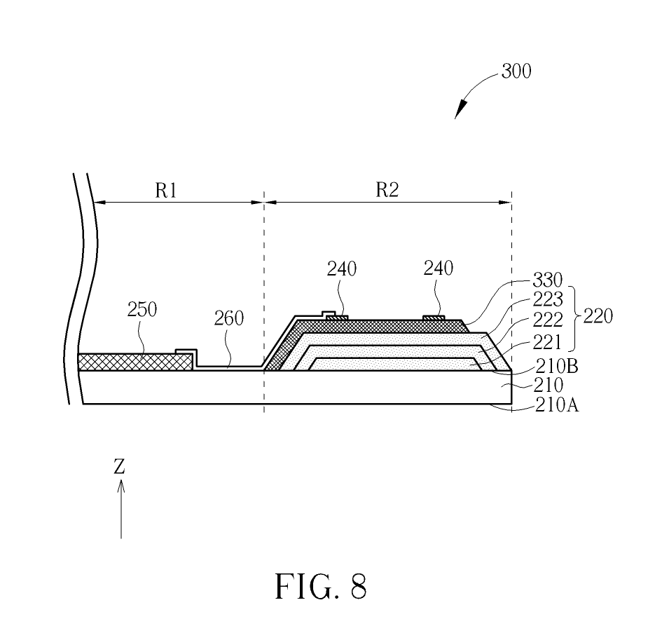

Please refer to FIG. 8. FIG. 8 is a schematic diagram illustrating a touch panel according to a fourth preferred embodiment of the present invention. As shown in FIG. 8, the fourth preferred embodiment of the present invention provides a touch panel 300. The difference between the touch panel 300 of this embodiment and the first preferred embodiment described above is that the touch panel 300 includes a first light-shielding layer 330 disposed on the decoration border 220. The first light-shielding layer 330 covers a side edge of the decoration border 220. The contour variation that the connecting portion 260 extends along may then become milder, and the reliability of the connecting portion 260 may accordingly be improved. Apart from the first light-shielding layer 330 in this embodiment, the other components, allocations, and material properties of the touch panel 300 in this embodiment are similar to those of the first preferred embodiment detailed above and will not be redundantly described. It is worth noting that the first light-shielding layer 330 in this embodiment extends to one side edge of the decoration border 220, and a color of the first light-shielding layer 330 is preferably identical to the colors of the first non-black decoration layer 221, the second non-black decoration layer 222, and the third non-black decoration layer 223 so as to avoid influencing the original visual effect of the decoration border 220. However, the color of the first light-shielding layer 330 may also be different from the colors of the first non-black decoration layer 221, the second non-black decoration layer 222, and the third non-black decoration layer 223 so as to generate different visual effects. For example, the first light-shielding layer 330 may be black for generating a visual effect that an inner edge of the decoration border 220 is surrounded with a black border. In other preferred embodiment of the present invention, the first light-shielding layer 330 may also extend to only another side edge of the decoration border 220 for generating a visual effect that an outer edge of the decoration border 220 is surrounded with a black border.

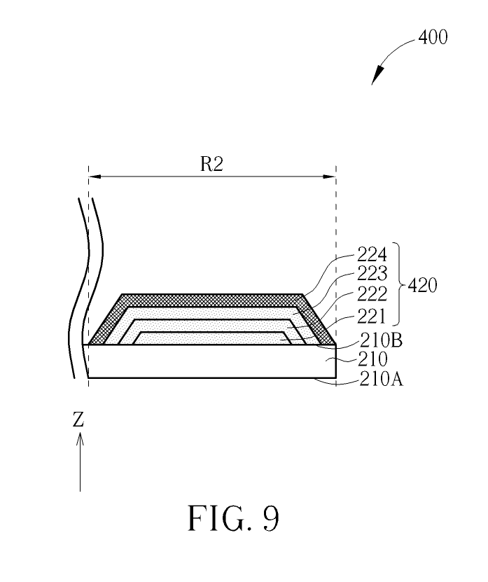

Please refer to FIG. 9. FIG. 9 is a schematic diagram illustrating a touch panel according to a fifth preferred embodiment of the present invention. As shown in FIG. 9, the fifth preferred embodiment of the present invention provides a touch panel 400. The difference between the touch panel 400 of this embodiment and the first preferred embodiment described above is that the touch panel 400 includes a decoration border 420 disposed on the cover substrate 210 within the peripheral region R2. The decoration border 420 includes the first non-black decoration layer 221, the second non-black decoration layer 222, the third non-black decoration layer 223, and a fourth non-black decoration layer 224 successively disposed in a stack configuration on the cover substrate 210 along the vertical projective direction Z. In other words, the fourth non-black decoration layer 224 is disposed on the third non-black decoration layer 223, and the fourth non-black decoration layer 224 covers the third non-black decoration layer 223 along the vertical projective direction Z. A pattern size of the fourth non-black decoration layer 224 is larger than the pattern size of the third non-black decoration layer 223. A demanded decoration effect may be presented on the peripheral region R2 of the touch panel 400 by stacking the first non-black decoration layer 221, the second non-black decoration layer 222, the third non-black decoration layer 223, and the fourth non-black decoration layer 224 in the peripheral region R2 and modifying colors of the first non-black decoration layer 221, the second non-black decoration layer 222, the third non-black decoration layer 223, and the fourth non-black decoration layer 224. In other words, the decoration border of the present invention may preferably include multiple non-black decoration layers, and all of the upper non-black decoration layers cover the lower non-black decoration layers, i.e. the subsequently formed non-black decoration layer is larger than the formerly formed non-black decoration layer, but the present invention is not limited to this. In other preferred embodiment of the present invention, only a part of the upper non-black decoration layers may cover the lower non-black decoration layers according to different considerations.

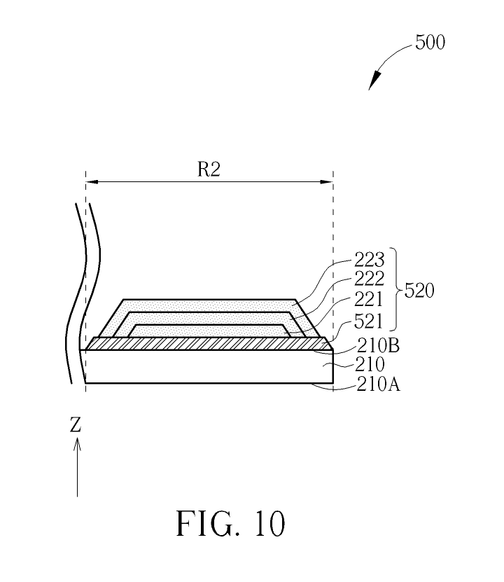

Please refer to FIG. 10. FIG. 10 is a schematic diagram illustrating a touch panel according to a sixth preferred embodiment of the present invention. As shown in FIG. 10, the sixth preferred embodiment of the present invention provides a touch panel 500. The difference between the touch panel 500 of this embodiment and the first preferred embodiment described above is that a decoration border 520 of the touch panel 500 further includes a bottom non-black decoration layer 521 disposed between the cover substrate 210 and the first non-black decoration layer 221, and a pattern size of the bottom non-black decoration layer 521 is larger than the pattern size of the first non-black decoration layer 221, the pattern size of the second non-black decoration layer 222, and the pattern size of the third non-black decoration layer 223. In other words, the bottom non-black decoration layer 521 is firstly formed on the cover substrate 210 for defining an appearance shape of the decoration border 520 in the peripheral region R2 of the touch panel 500. The pattern size of the subsequently formed first non-black decoration layer 221, the pattern size of the subsequently formed second non-black decoration layer 222, and the pattern size of the subsequently formed third non-black decoration layer 223 are all smaller than the pattern size of the bottom non-black decoration layer 521. A visibility of the interfaces between the first non-black decoration layer 221, the second non-black decoration layer 222, and the third non-black decoration layer 223 may be decreased by the bottom non-black decoration layer 521, and the appearance quality of the decoration border 520 may be accordingly enhanced. Apart from the bottom non-black decoration layer 521 in this embodiment, the other components, allocations, and material properties of the touch panel 500 in this embodiment are similar to those of the first preferred embodiment detailed above and will not be redundantly described.

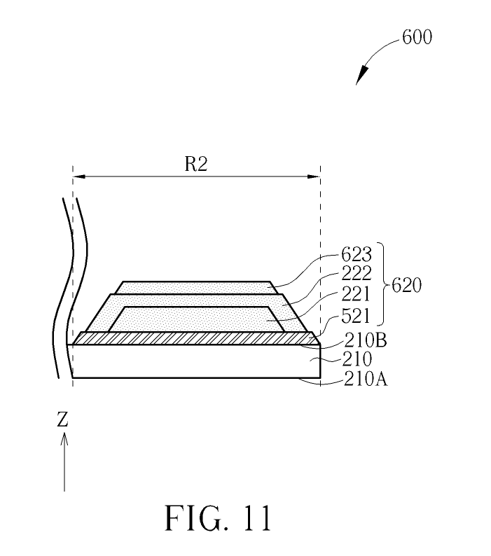

Please refer to FIG. 11. FIG. 11 is a schematic diagram illustrating a touch panel according to a seventh preferred embodiment of the present invention. As shown in FIG. 11, the seventh preferred embodiment of the present invention provides a touch panel 600. The difference between the touch panel 600 of this embodiment and the sixth preferred embodiment described above is that the touch panel 600 includes a decoration border 620 disposed on the cover substrate 210 within the peripheral region R2. The decoration border 620 includes the bottom non-black decoration layer 521, the first non-black decoration layer 221, the second non-black decoration layer 222, and a third non-black decoration layer 623 successively disposed in a stack configuration on the cover substrate 210 along the vertical projective direction Z. A pattern size of the third non-black decoration layer 623 is smaller than the pattern size of the second non-black decoration layer 222. Apart from the third non-black decoration layer 623 in this embodiment, the other components, allocations, and material properties of the touch panel 600 in this embodiment are similar to those of the sixth preferred embodiment detailed above and will not be redundantly described.

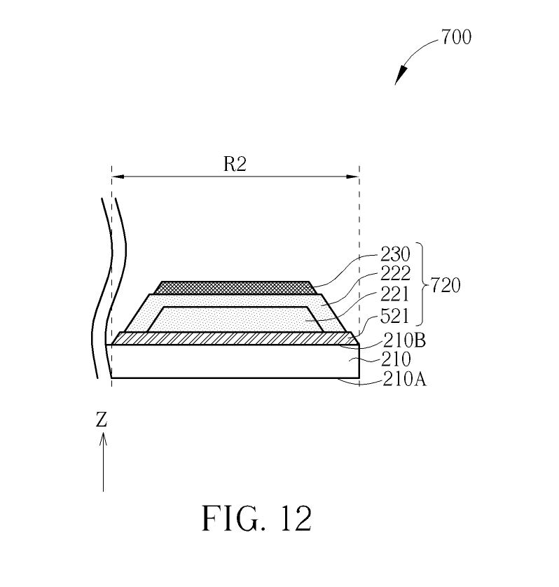

Please refer to FIG. 12. FIG. 12 is a schematic diagram illustrating a touch panel according to an eighth preferred embodiment of the present invention. As shown in FIG. 12, the eighth preferred embodiment of the present invention provides a touch panel 700. The difference between the touch panel 700 of this embodiment and the sixth preferred embodiment described above is that the touch panel 700 includes a decoration border 720 disposed on the cover substrate 210 within the peripheral region R2. The decoration border 720 includes the bottom non-black decoration layer 521, the first non-black decoration layer 221, and the second non-black decoration layer 222 successively disposed in a stack configuration on the cover substrate 210 along the vertical projective direction Z. The first light-shielding layer 230 is directly disposed on the second non-black decoration layer 222, but not limited thereto. In this embodiment, a demanded decoration effect may be presented on the peripheral region R2 of the touch panel 700 by stacking the bottom non-black decoration layer 521, the first non-black decoration layer 221, and the second non-black decoration layer 222 in the peripheral region R2.

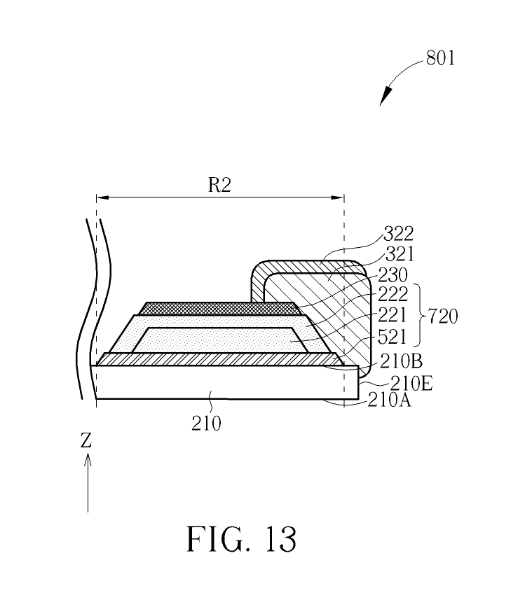

Please refer to FIG. 13. FIG. 13 is a schematic diagram illustrating a touch panel according to a ninth preferred embodiment of the present invention. As shown in FIG. 13, a touch panel 801 is provided in this embodiment. The difference between the touch panel 801 of this embodiment and the eighth preferred embodiment described above is that the touch panel 801 further includes a fifth non-black decoration layer 321 and a second light-shielding layer 322. The fifth non-black decoration layer 321 is disposed on an edge 210E of the cover substrate 210 and at least partially covers the decoration border 720 and the first light-shielding layer 230. The second light-shielding layer 322 is disposed on the fifth non-black decoration layer 321, and the second light-shielding layer 322 at least partially overlaps the first light-shielding layer 230 along the vertical projective direction Z. The fifth non-black decoration layer 321 and the second light-shielding layer 322 may respectively include a color ink layer, a color photoresist layer, or a metal layer, but not limited thereto. For example, the fifth non-black decoration layer 321 may be a white ink layer and the second light-shielding layer 322 may be a black ink layer or a material capable of transmitting infrared light (such as IR ink). It is worth noting that a side of the fifth non-black decoration layer 321 may preferably project from a side of the second light-shielding layer 322 at the edge 210E of the cover substrate 210 so as to prevent a black border around the decoration border 720. More specifically, a distance between the side of the fifth non-black decoration layer 321 and the side of the second light-shielding layer 322 at the edge 210E of the cover substrate 210 may be around 0.1 mm, but not limited thereto. Additionally, the fifth non-black decoration layer 321 and the second light-shielding layer 322 are preferably formed after a cutting process of the cover substrate 210 so as to prevent light leakage around a region between the edge 210E and the decoration border 720. The fifth non-black decoration layer 321 and the second light-shielding layer 322 may also be applied in all of the embodiments in the present invention according to different design considerations.

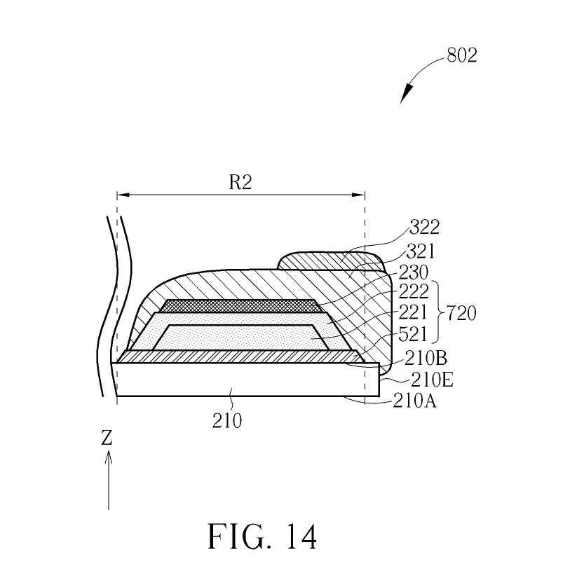

Please refer to FIG. 14. FIG. 14 is a schematic diagram illustrating a touch panel according to a tenth preferred embodiment of the present invention. As shown in FIG. 14, a touch panel 802 is provided in this embodiment. The difference between the touch panel 802 of this embodiment and the ninth preferred embodiment described above is that the fifth non-black decoration layer 321 in this embodiment may further extend to overlap an edge of the bottom non-black decoration layer 521 adjacent to the touch sensing region (not shown in FIG. 14) and completely cover the first non-black decoration layer 221, the second non-black decoration layer 222 and the first light-shielding layer 230 along the vertical projective direction Z so as to compensate color differences at a side of the decoration border 720 adjacent to the touch sensing region (not shown in FIG. 14).

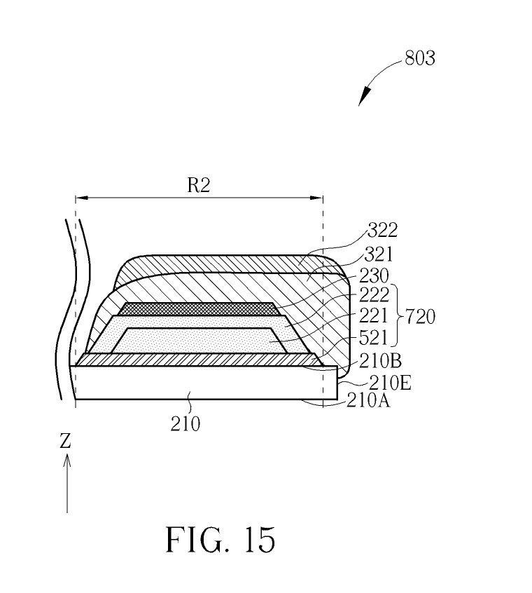

Please refer to FIG. 15. FIG. 15 is a schematic diagram illustrating a touch panel according to an eleventh preferred embodiment of the present invention. As shown in FIG. 15, a touch panel 803 is provided in this embodiment. The difference between the touch panel 803 of this embodiment and the tenth preferred embodiment described above is that the second light-shielding layer 322 in this embodiment may further extend to overlap the first light-shielding layer 230 and the first non-black decoration layer 221 along the vertical projective direction Z so as to further enhance the light shielding effect. It is worth noting that, in this embodiment, the second light-shielding layer 322 may preferably not overlap an edge of the second non-black decoration layer 222 adjacent to the touch sensing region (not shown in FIG. 14) so as to prevent a black border from being generated at the edge of the second non-black decoration layer 222 adjacent to the touch sensing region.

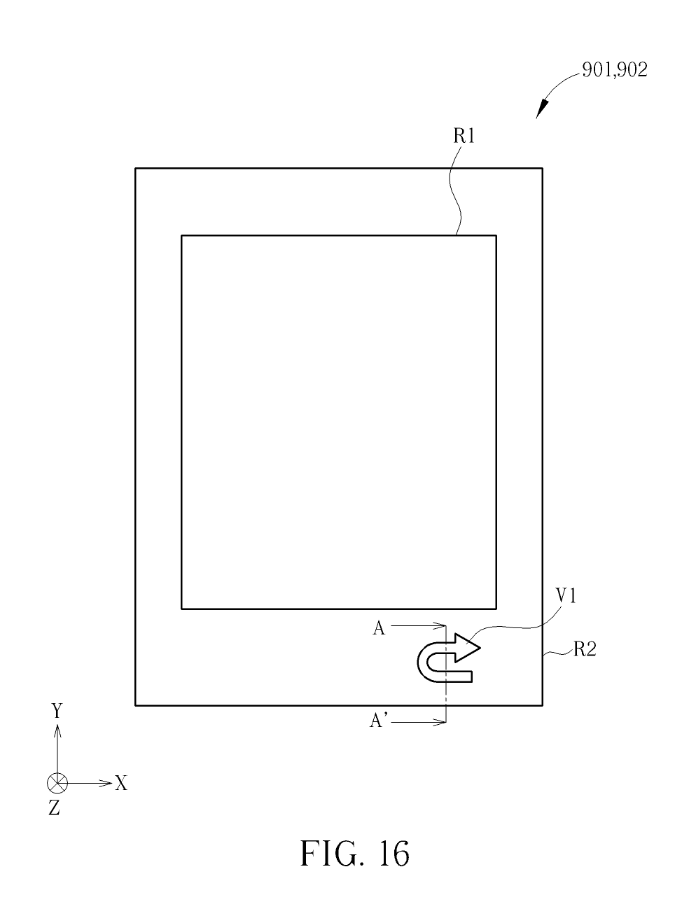

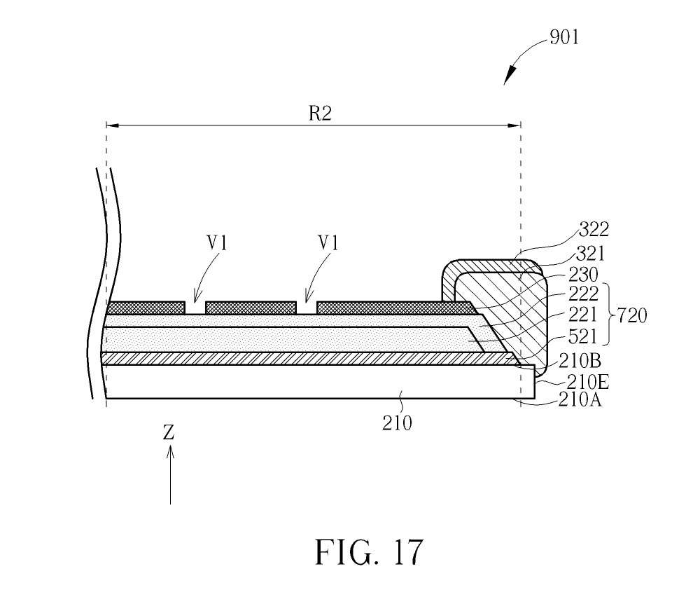

Please refer to FIG. 16 and FIG. 17. FIG. 16 is a schematic diagram illustrating a top view of a touch panel according to a twelfth preferred embodiment of the present invention. FIG. 17 is a schematic diagram illustrating a cross-sectional view of the touch panel in this embodiment. FIG. 17 may be regarded as a cross-sectional view diagram taken along a cross-sectional line A-A′ in FIG. 16. As shown in FIG. 16 and FIG. 17, a touch panel 901 is provided in this embodiment. The difference between the touch panel 901 of this embodiment and the ninth preferred embodiment described above is that the touch panel 901 further includes a patterned hole V1 in the first light-shielding layer 230, and the patterned hole V1 partially exposes the second non-black decoration layer 222 in this embodiment. In other words, the patterned hole V1 in this embodiment only penetrates through the first light-shielding layer 230 for presenting a figure in the peripheral region R2. Therefore, the patterned hole V1 may have restricted light-transmittance to be barely visible when the touch panel 901 is not turned on. It is worth noting that the patterned hole V1 may be used to present an icon with touch functions, an indication light mark such as a power indication, or other appropriate applications (such as a text or a symbol, wherein the text may be a letter, trademark, logo or Arabic number, and the symbol may be an icon, graphics, geometric conformation or a hole).

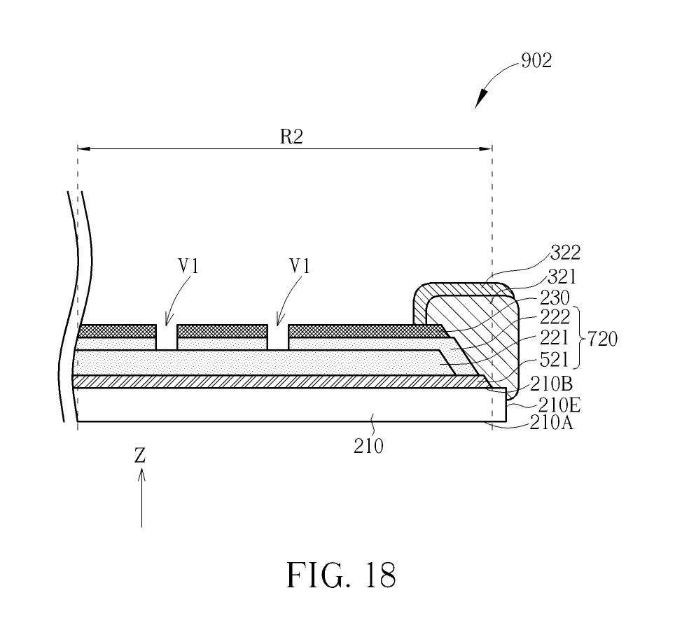

Please refer to FIG. 18 and FIG. 16. FIG. 16 is a schematic diagram illustrating a top view of a touch panel according to a thirteenth preferred embodiment of the present invention. FIG. 18 is a schematic diagram illustrating a cross-sectional view of the touch panel in this embodiment. FIG. 18 may be regarded as a cross-sectional view diagram taken along a cross-sectional line A-A′ in FIG. 16. As shown in FIG. 16 and FIG. 18, a touch panel 902 is provided in this embodiment. The difference between the touch panel 902 of this embodiment and the twelfth preferred embodiment described above is that the patterned hole V1 in this embodiment is disposed in the first light-shielding layer 230 and the second non-black decoration layer 222, and the patterned hole V1 partially exposes the first non-black decoration layer 221. In other words, the patterned hole V1 in this embodiment penetrates through the first light-shielding layer 230 and the second non-black decoration layer 222 for presenting a figure in the peripheral region R2. It is worth noting that in other preferred embodiment in the present invention, the patterned hole V1 may also extent to the first non-black decoration layer 221 or the bottom non-black decoration layer 521 for presenting required effects.

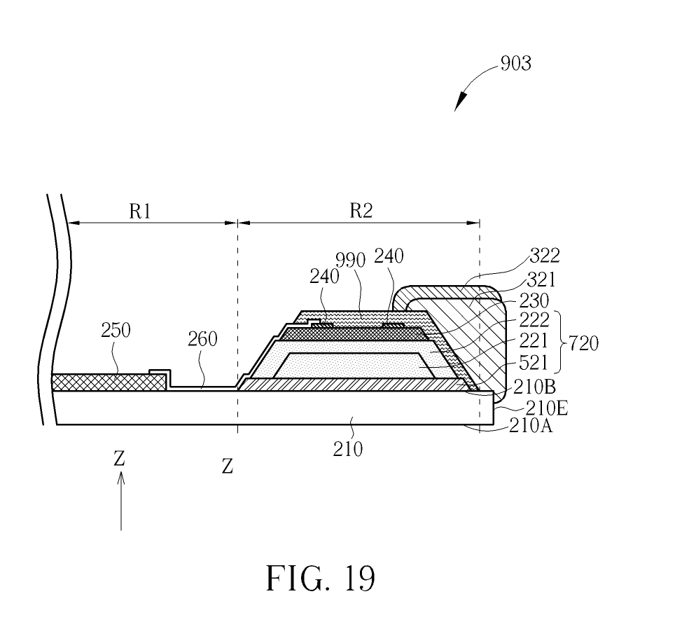

Please refer to FIG. 19. FIG. 19 is a schematic diagram illustrating a touch panel according to a fourteenth preferred embodiment of the present invention. As shown in FIG. 19, a touch panel 903 is provided in this embodiment. The difference between the touch panel 903 of this embodiment and the ninth preferred embodiment described above is that the touch panel 903 further includes an insulating layer 990 disposed between the fifth non-black decoration layer 321 and the decoration border 720. The insulation layer 990 may include inorganic materials such as silicon nitride, silicon oxide and silicon oxynitride, organic materials such as acrylic resin, organic-inorganic hybrid multi-layers, or other appropriate materials.

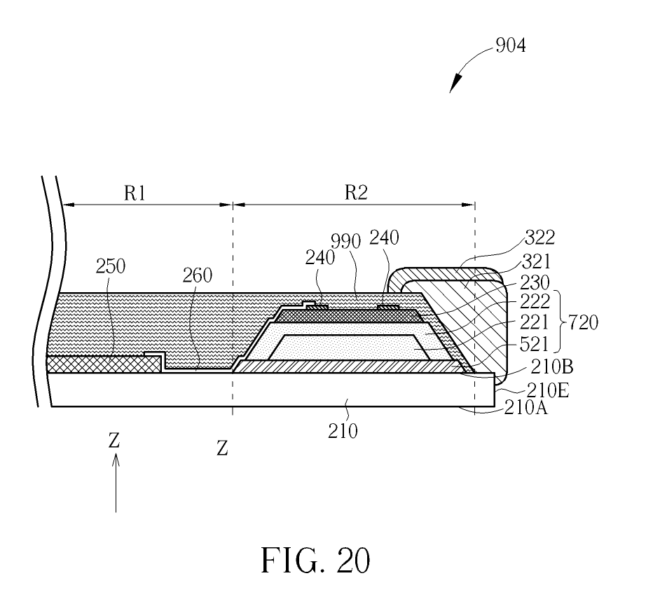

Please refer to FIG. 20. FIG. 20 is a schematic diagram illustrating a touch panel according to a fifteenth preferred embodiment of the present invention. As shown in FIG. 20, a touch panel 904 is provided in this embodiment. The difference between the touch panel 904 of this embodiment and the fourteenth preferred embodiment described above is that the insulating layer 990 in this embodiment is disposed in both the touch sensing region R1 and the peripheral region R2. The insulating layer 990 in this embodiment may be used to protect the decoration border 720, the conductive wiring 240, the touch sensing unit 250, and the connecting portion 260. It is noted that the foregoing non-black decoration layers are for illustration only and thus the black decoration layers may also be adopted for demanded decoration effect.

To summarize the above descriptions, in the touch panel of the present invention, the decoration layers are disposed in the peripheral region in a stack configuration. The upper decoration layer covers the lower decoration layer for preventing the cracking issue on the subsequently formed connecting line or connecting portion which is generated by the severe contour variation on the edge of the stacked decoration layers. The reliability of the touch panel may be accordingly improved. Additionally, the width and the space control of the conductive wiring in the peripheral region may also be more flexible because the upper decoration layer covers the lower decoration layer, and the flexibility of the layout design in the touch panel may be accordingly increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch panel, having a touch sensing region and a peripheral region adjacent to at least one edge of the touch sensing region, the touch panel comprising:
a cover substrate, having a touch surface and an inner surface opposite to the touch surface; and
a decoration border, disposed on the inner surface of the cover substrate within the peripheral region, the decoration border comprising:
a first non-black decoration layer; and
a second non-black decoration layer, disposed on the first non-black decoration layer, wherein the first non-black decoration layer is disposed between the cover substrate and the second non-black decoration layer, the second non-black decoration layer covers the first non-black decoration layer along a vertical projective direction, and a pattern size of the second non-black decoration layer is larger than a pattern size of the first non-black decoration layer.

2. The touch panel of claim 1, wherein an optical density (OD) of the second non-black decoration layer is higher than an optical density of the first non-black decoration layer.

3. The touch panel of claim 1, wherein the decoration border further comprises a third non-black decoration layer disposed on the second non-black decoration layer, wherein the third non-black decoration layer covers the second non-black decoration layer and the first non-black decoration layer along the vertical projective direction, and a pattern size of the third non-black decoration layer is larger than the pattern size of the second non-black decoration layer.

4. The touch panel of claim 3, wherein an optical density of the third non-black decoration layer is higher than an optical density of the second non-black decoration layer.

5. The touch panel of claim 3, wherein the first non-black decoration layer, the second non-black decoration layer, and the third non-black decoration layer comprise a color ink layer, a color photoresist layer, or a metal layer.

6. The touch panel of claim 1, wherein the decoration border further comprises a bottom non-black decoration layer disposed between the cover substrate and the first non-black decoration layer, and a pattern size of the bottom non-black decoration layer is larger than the pattern size of the second non-black decoration layer.

7. The touch panel of claim 1, further comprising a first light-shielding layer, disposed on the decoration border, wherein the first light-shielding layer covers at least one side edge of the decoration border.

8. The touch panel of claim 1, further comprising:
a touch sensing unit, disposed on the inner surface of the cover substrate within the touch sensing region;
a conductive wiring, disposed on the decoration border within the peripheral region; and
a connecting portion, disposed on the inner surface of the cover substrate, wherein the connecting portion is used to electrically connect the touch sensing unit and the conducting wiring.

9. The touch panel of claim 8, wherein the connecting portion extends along a side edge of the decoration border for being electrically connected with the conductive wiring.

10. The touch panel of claim 8, wherein the touch sensing unit comprises a plurality of first axis electrodes and a plurality of second axis electrodes, and the first axis electrodes cross the second axis electrodes.

11. The touch panel of claim 8, wherein the touch sensing unit comprises a plurality of sensing electrodes, and the sensing electrodes are disposed separately with each other.

12. The touch panel of claim 6, further comprising:
a first light-shielding layer, disposed on the decoration border;
a fifth non-black decoration layer, disposed on an edge of the cover substrate and at least partially covering the decoration border and the first light-shielding layer; and
a second light-shielding layer, disposed on the fifth non-black decoration layer, wherein the second light-shielding layer at least partially overlaps the first light-shielding layer along the vertical projective direction.

13. The touch panel of claim 12, wherein a side of the fifth non-black decoration layer projects from a side of the second light-shielding layer at the edge of the cover substrate.

14. The touch panel of claim 12, wherein the fifth non-black decoration layer extends to overlap an edge of the bottom non-black decoration layer adjacent to the touch sensing region and completely covers the first non-black decoration layer, the second non-black decoration layer and the first light-shielding layer along the vertical projective direction.

15. The touch panel of claim 12, wherein the second light-shielding layer extends to overlap the first light-shielding layer and the first non-black decoration layer along the vertical projective direction.

16. The touch panel of claim 12, further comprising a patterned hole in the first light-shielding layer, wherein the patterned hole partially exposes the second non-black decoration layer.

17. The touch panel of claim 12, further comprising a patterned hole in the first light-shielding layer and the second non-black decoration layer, wherein the patterned hole partially exposes the first non-black decoration layer.

18. The touch panel of claim 12, further comprising an insulating layer disposed between the fifth non-black decoration layer and the decoration border.

19. The touch panel of claim 18, wherein the insulating layer is disposed in the touch sensing region and the peripheral region.

20. A touch panel, having a touch sensing region and a peripheral region adjacent to at least one edge of the touch sensing region, the touch panel comprising:
a cover substrate; and
a decoration border, disposed on the cover substrate within the peripheral region, the decoration border comprising:
a first non-black decoration layer; and
a second non-black decoration layer, adjacent to the first non-black decoration layer, wherein the first non-black decoration layer is disposed between the cover substrate and the second non-black decoration layer, and the second non-black decoration layer encompasses the first non-black decoration layer.

21. A touch panel, having a touch sensing region and a peripheral region adjacent to at least one edge of the touch sensing region, the touch panel comprising:
a cover substrate, and
a decoration border, disposed on the cover substrate within the peripheral region, the decoration border comprising:
a first non-black decoration layer; and
a second non-black decoration layer, adjacent to the first non-black decoration layer, wherein the first non-black decoration layer is disposed between the cover substrate and the second non-black decoration layer, and the second non-black decoration layer covers the first non-black decoration layer along a vertical projective direction.
